(19) United States
(12) Patent Application Publication
(10) Pub. No.: US 2018/0283079 A1
(43) Pub. Date: Oct. 4, 2018

(54) ELECTRICALLY-PROPELLED CAR WINDOW

(71) Applicant: Primax Electronics Ltd., Taipei (TW)

(72) Inventor: Kuan-Pao Ting, Taipei (TW)

(21) Appl. No.: 15/792,080

(22) Filed: Oct. 24, 2017

(30) Foreign Application Priority Data
Mar. 31, 2017 (TW) 106111017

(51) Int. Cl. E05F 15/75; E05F 15/60; B60J 1/17; B60J 5/04

(52) U.S. Cl. CPC E05F 15/75; E05F 15/60; B60J 1/17; E05Y 2900/55; E05Y 2400/45; E05Y 2400/85; B60J 5/0412

(57) ABSTRACT

The present invention provides an electrically-propelled car window, including a glass window, a control assembly, and a recognizing module. The control assembly is connected to the glass window. The recognizing module is installed on the glass window and is electrically connected to the control assembly. The recognizing module stores recognition data. The recognizing module acquires an acquisition signal. When the acquisition signal matches the recognition data, the control assembly is made to drive the glass window to descend, so as to unlock a car door locked from outside.

### FIELD OF THE INVENTION

The present invention relates to an electrically-propelled car window.

### BACKGROUND OF THE INVENTION

In daily life, cars have become indispensable vehicles for modern people. Most families with children buy a car, to send the children to school or pick up the children after school, send the children to a babysitter's house, buy necessities, go to hospital, or the like.

However, with the progress of technologies, for convenience of use, car doors are now locked or unlocked in a remote control manner instead of the conventional manner of using keys.

Therefore, when there is a child in a car, and a driver needs to temporarily park and leave the child in the car in some unpredictable cases, for example, cases of self-fueling and paying in a convenience store, in such cases, if the driver forgets to bring the key and leaves the key inside the car, and the naughty child left in the car locks the car door, or if the driver leaves the key inside the car and locks himself or herself outside the car, the driver has to break the car window, and unlock the car window by opening the car door by stretching out his or her hand into the car from the broken window. Moreover, in this case, the driver needs to pay extra fees for car window repairing. Therefore, this problem needs to be urgently resolved.

### SUMMARY OF THE INVENTION

A main objective of the present invention is to provide an electrically-propelled car window.

In a preferred embodiment, the present invention provides an electrically-propelled car window. The electrically-propelled car window is installed on a car door. The electrically-propelled car window includes a glass window, a control assembly, and a recognizing module. The glass window is installed on the car door. The control assembly is installed inside the car door and is connected to the glass window. The recognizing module is installed on the glass window and is electrically connected to the control assembly. The recognizing module stores recognition data, where the recognizing module acquires an acquisition signal matching the recognition data, and makes the control assembly drive the glass window to descend into the car door, so as to unlock, by using the recognizing module, the car door locked from outside.

Preferably, the recognizing module is installed on an inner side surface of the glass window. Preferably, the recognizing module includes an acquisition element and a control unit, the control unit is electrically connected to the control assembly, the acquisition element is electrically connected to the control unit, and the acquisition element acquires the acquisition signal. Preferably, the recognizing module further includes a memory element, the memory element is electrically connected to the control unit, and the recognition data is stored in the memory element. Preferably, the acquisition element is a fingerprint acquisition element, the control unit is a microcontroller, and the memory element is a memory.

Preferably, the control assembly includes: a control element, a drive element, and a glass lifting member, the control unit and the drive element are separately electrically connected to the control element, the drive element is connected to the glass lifting member, the glass lifting member is connected to the glass window, and the drive element can drive the glass lifting member to make the glass window descend. Preferably, the control element is an automobile microcontroller, the drive element is a motor, and the glass lifting member is a glass lifter.

Preferably, the control assembly further includes a lifting switch element, and the switch element electrically connected to the control element, to raise or lower the glass window by operating the lifting switch element.

Preferably, the control assembly further includes a power supply element; the control unit, the control element, and the drive element are separately electrically connected to the power supply element; and the power supply element is a power supply.

### BRIEF DESCRIPTION OF THE DRAWINGS

FIG. 1 is a first schematic diagram of an electrically-propelled car window according to the present invention;

FIG. 2 is a second schematic diagram of the electrically-propelled car window according to the present invention;

FIG. 3 is a control diagram of the electrically-propelled car window according to the present invention; and

FIG. 4 is a diagram of a used state of the electrically-propelled car window according to the present invention.

### DETAILED DESCRIPTION OF THE PREFERRED EMBODIMENT

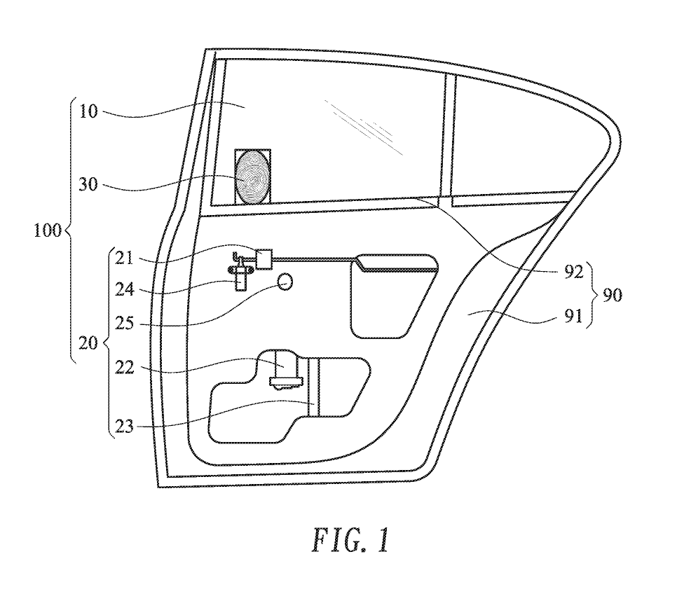

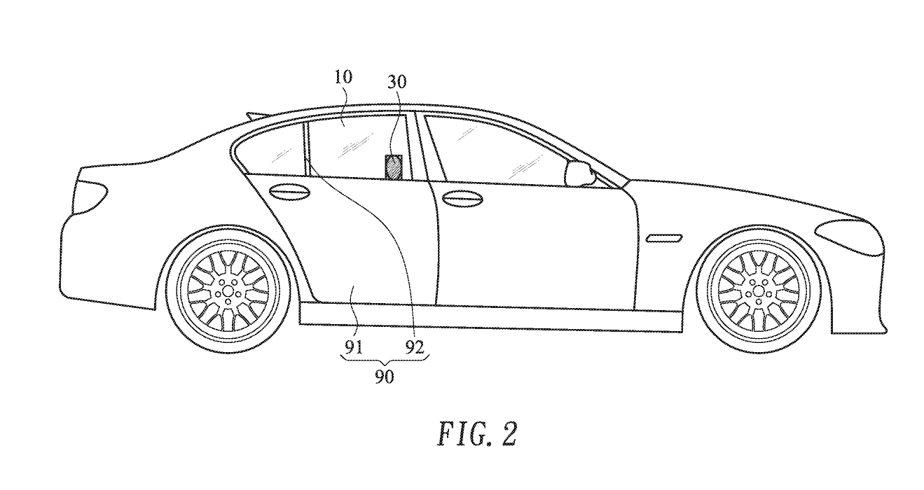

Referring to FIG. 1 and FIG. 2, FIG. 1 and FIG. 2 are respectively a first schematic diagram of and a second schematic diagram of an electrically-propelled car window according to the present invention. The electrically-propelled car window 100 is installed on a car door 90. The electrically-propelled car window 100 includes: a glass window 10, a control assembly 20, and a recognizing module 30.

The car door 90 includes a body 91 and a window frame 92 extending upwards from the body 91. The body 91 is provided with an installation space and a glass accommodation space. The glass accommodation space is in communication with the window frame 92. The glass window 10 is installed within the window frame 92 of the car door 90.

The control assembly 20 is installed in the installation space of the car door 90. The control assembly 20 includes: a control element 21, a drive element 22, a glass lifting member 23, a lifting switch element 24, and a power supply element 25. The drive element 22 is connected to the glass lifting member 23. The glass lifting member 23 is connected to the glass window 10. The drive element 22 can drive the glass lifting member 23 to make the glass window 10 descend. The control element 21 is an automobile microcontroller. The drive element 22 is a motor. The glass lifting member 23 is a glass lifter. The power supply element 25 is a power supply. The recognizing module 30 is installed on an inner side surface of the glass window 10.

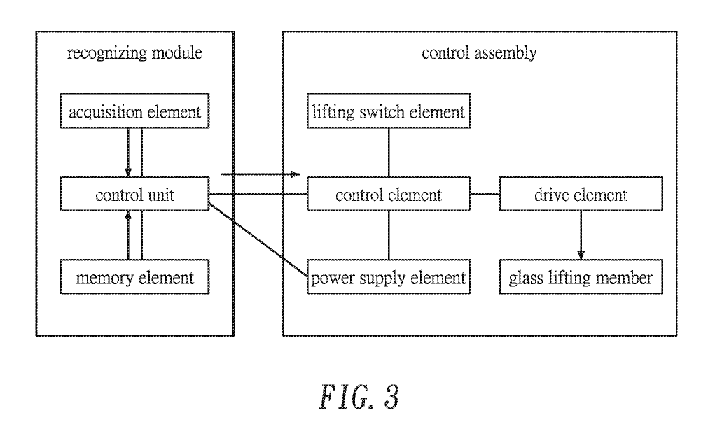

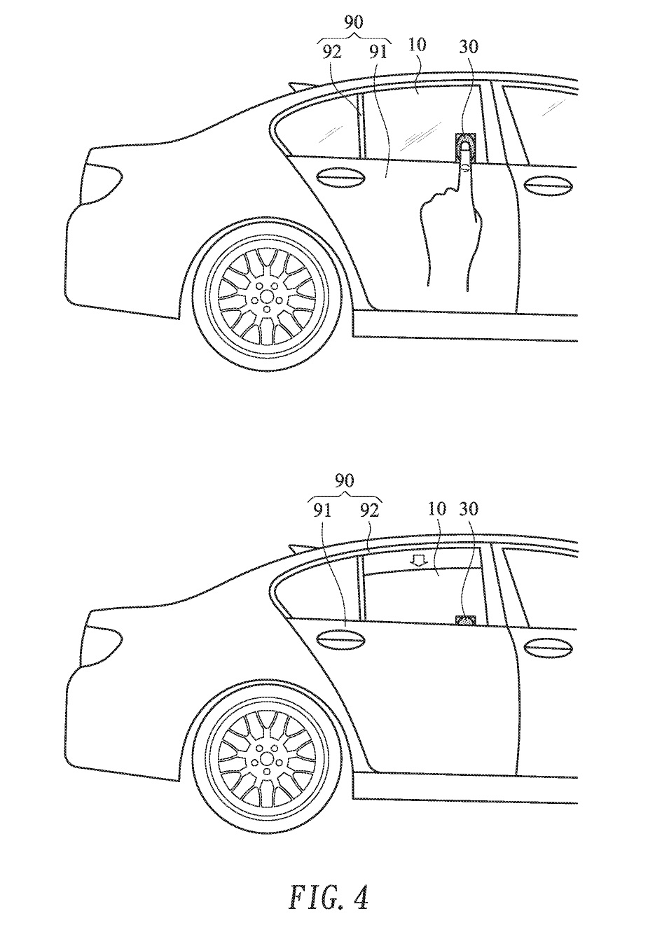

Referring to FIG. 3 and FIG. 4, FIG. 3 and FIG. 4 are respectively a control diagram and a diagram of a used state of the electrically-propelled car window according to the present invention. The control element 21 of the control assembly 20 is separately electrically connected to the drive element 22, a lifting switch element 24, and the power supply element 25. The power supply element 25 is electrically connected to the drive element 22. The power supply element 25 supplies power to the control element 21 and the drive element 22.

The recognizing module 30 includes: an acquisition element 31, a control unit 32, and a memory element 33. The acquisition element 31 is a fingerprint acquisition element. The control unit 32 is a microcontroller. The memory element 33 is a memory. The control unit 32 is electrically connected to the control element 21 and the power supply element 25. The power supply element 25 supplies power to the recognizing module 30. The acquisition element 31 and the memory element 33 are separately electrically connected to the control unit 32. When a finger is pressed on the recognizing module 30, the acquisition element 31 can acquire a fingerprint feature and generates an acquisition signal 311. The memory element 33 prestores recognition data 331 including the fingerprint feature of a user.

When the car door is locked from outside due to improper use, a user can press a finger on the recognizing module 30 installed on the glass window 10 outside the car, to make the acquisition element 31 of the recognizing module 30 acquire a fingerprint feature of the user and generate the acquisition signal 311. When detecting the acquisition signal 311 generated by the acquisition element 31, the control unit 32 of the recognizing module 30 reads the fingerprint feature in the acquisition signal 311, simultaneously reads, from the memory element 33, the recognition data 331 stored in the memory element 33, and then compares, in the control unit 32, whether the fingerprint feature included in the acquisition signal 311 matches the fingerprint feature included in the recognition data 331 in the memory element 33. When the fingerprint feature included in the acquisition signal 311 matches the fingerprint feature in the recognition data 331, the control unit 32 transmits a control signal 321 to the control element 21 of the control assembly 20. After receiving the control signal 321, the control element 21 drives the drive element 22 to operate to drive the glass lifting member 23 to lower the glass window 10 from the window frame 92 into the glass accommodation space of the body 91, so that the user can stretch out a hand into the car from the window frame 92 of the car door 90 to manually unlock and open the car door 90. Therefore, when improperly locked from outside, the car door 90 can be opened in a fingerprint recognition manner instead of breaking the glass window 10 installed on the car door 90.

In addition, when the car door 90 locked from outside is opened by using the recognizing module 30, the control unit 32 needs to compare whether the acquisition signal 311 matches the recognition data 331 stored in the memory element 33, and the glass window 10 descends into the car door 90 only when the acquisition signal 311 matches the recognition data 331. Therefore, the car door 90 locked from outside cannot be opened by a fingerprint that is not the fingerprint of the user. In this way, a case in which a person which is not the user opens the car door 90 locked from outside is prevented.

Moreover, when the user can manually operate the lifting switch element 24, the control element 21 drives the drive element 22 to operate to drive the glass lifting member 23 to raise the glass window 10 from the glass accommodation space of the car door 90 to the window frame 92, or lower the glass window 10 from the window frame 92 into the glass accommodation space, so as to raise or lower the glass window 10 by operating the lifting switch element 24.

It can be known according to the foregoing descriptions that, first, the car door 90 locked from outside can be opened by using the control assembly 20 and the recognizing module 30, and a case in which a person who is not the user can open the car door 90 locked from outside is prevented; and secondly, the glass window 10 can be raised or lowered by operating the lifting switch element 24 on the car door 90.

The foregoing are merely preferred embodiments of the present invention, and are not intended to limit the claims of the present invention, and therefore any other equivalent variation or modification made under the spirit disclosed in the present invention is subject to the appended claims.

What is claimed is:

1. An electrically-propelled car window, installed on a car door, and comprising:
a glass window, installed on the car door;
a control assembly, installed inside the car door and connected to the glass window; and
a recognizing module, installed on the glass window and electrically connected to the control assembly, the recognizing module storing recognition data, wherein
the recognizing module acquires an acquisition signal matching the recognition data, and makes the control assembly drive the glass window to descend into the car door.

2. The electrically-propelled car window according to claim 1, wherein the recognizing module is installed on an inner side surface of the glass window.

3. The electrically-propelled car window according to claim 1, wherein the recognizing module comprises an acquisition element and a control unit, the control unit is electrically connected to the control assembly, the acquisition element is electrically connected to the control unit, and the acquisition element acquires the acquisition signal.

4. The electrically-propelled car window according to claim 3, wherein the recognizing module further comprises a memory element, the memory element is electrically connected to the control unit, and the recognition data is stored in the memory element.

5. The electrically-propelled car window according to claim 4, wherein the acquisition element is a fingerprint acquisition element, the control unit is a microcontroller, and the memory element is a memory.

6. The electrically-propelled car window according to claim 3, wherein the control assembly comprises: a control element, a drive element, and a glass lifting member, the control unit and the drive element are separately electrically connected to the control element, the drive element is connected to the glass lifting member, the glass lifting member is connected to the glass window, and the drive element can drive the glass lifting member to make the glass window descend.

7. The electrically-propelled car window according to claim 6, wherein the control element is an automobile microcontroller, the drive element is a motor, and the glass lifting member is a glass lifter.

8. The electrically-propelled car window according to claim 6, wherein the control assembly further comprises a lifting switch element, and the switch element is electrically connected to the control element.

9. The electrically-propelled car window according to claim 8, wherein the control assembly further comprises a power supply element, and the control unit, the control element, and the drive element are separately electrically connected to the power supply element.

10. The electrically-propelled car window according to claim 9, wherein the power supply element is a power supply.
